(19) United States
(12) Patent Application Publication
(10) Pub. No.: US 2004/0238333 A1
(43) Pub. Date: Dec. 2, 2004

(54) Link conveyor especially for round-bale presses

(76) Inventor: Thomas Schuster, Kammlach (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/479,450

(22) PCT Filed: Jun. 3, 2002
(86) PCT No.: PCT/EP02/06056

(30) Foreign Application Priority Data
Jun. 2, 2001 (DE) 201 09 161.5

(51) Int. Cl. B65G 17/06

(52) U.S. Cl. 198/853

(57) ABSTRACT

A link conveyor, such as for use with a round bale press frequently used for compacting garbage, where the link conveyor includes a plurality of link strips which have multi-chamber extruded profiles which are mutually interconnected at their ends in an articulated manner by means of round rods and where the round rods fit into oblong hole profiles. The link conveyor provides extended working life by providing sacrificial wear areas and also facilitates replacement of worn parts.

The invention relates to a link conveyor, especially for round-bale presses for compacting garbage, comprising a plurality of aluminum link strips which especially consist of multi-chamber extruded profiles which are mutually interconnected at their ends in an articulated manner by means of round rods.

Such a link conveyor is known from WO 00/06367. In this case the individual link strips of the link conveyor are connected by rods which are inserted on the one side in bores with loose fit and on the opposite side in bores with transition fit. This processing of the bores with different tolerances is very laborious from a production viewpoint even in the case of a configuration as an extruded part. Moreover, wear and tear is relatively high especially in the bore with the loose fit, so that the continuous belt will be subject to high wear and tear especially when used for compacting garbage. Notice must be taken that such a link conveyor can have a length of more than 10 m and can consist of more than 200 link strips. When reaching the wearing limit it is thus necessary to exchange the entire link conveyor, which is very time-consuming and expensive since the rods are frequently canted and/or are out of true, making them very difficult to dismount from the bores.

The invention is therefore based on the object of providing a link conveyor which is easier to produce and is subject to less wear and tear, so that overall a higher service life and lower costs can be obtained.

This object is achieved by a link conveyor according to the features of claim 1. Preferred embodiments are the subject matter of the sub-claims.

By inserting the rode in oblong hole profiles, the link strips which are produced in an, aluminum extrusion process can be inserted in a simple manner and without complicated production. Substantial savings in costs are thus achieved. Moreover, the oblong hole profiles, and especially the leading end, comes with a higher wall thickness, thus creating an intentional wearing zone. Moreover, the insertion of the round rods into the oblong hole profiles during mounting and the removal of the same during dismounting are especially simple because the round rods can be inserted easier into the diameter-enlarged region of the oblong hole profile and can be fixed there or removed from there.

This occurs for example by means of screws aligned in the running direction of the conveyor, which screws are inserted in one of the adjacent chamber profiles of the link strips. In an especially advantageous embodiment the round rods are clamped by inclines which taper conically by a few degrees of angle, so that during the stretching process after the mounting the round rods are pulled into the eye of the oblong hole profile and are fixed there because the eye widens slightly In this process. This clamping prevents the co-rotation of the rod which occurs in the state of the art, with an axial fixing being ensured simultaneously. A slight blow of the hammer is sufficient for dismounting, so that the round rod can then be removed easily.

An embodiment of the link strip is explained and described below by reference to the drawings, wherein:

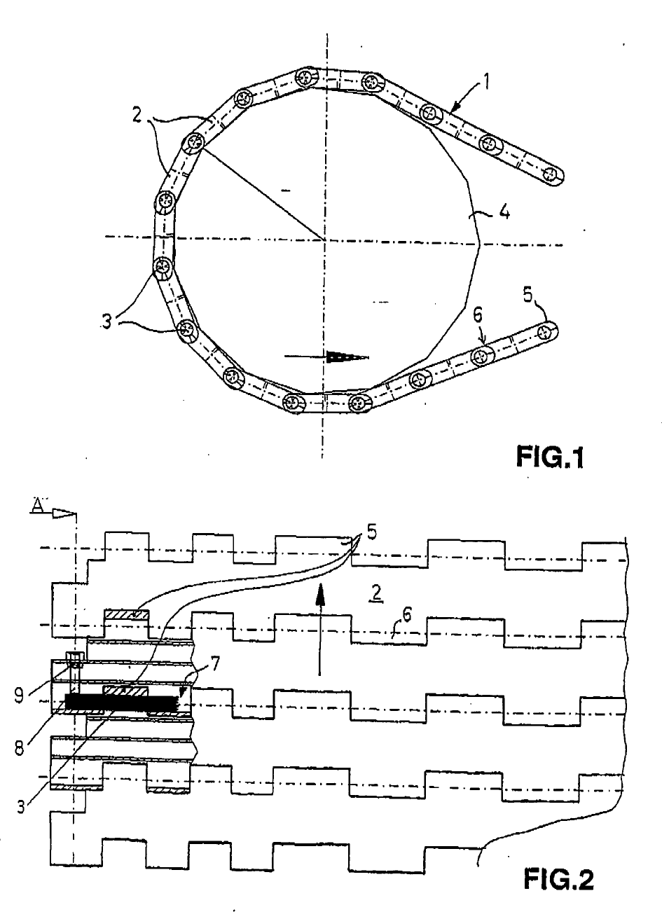

FIG. 1 shows a side view of a link conveyor which revolves about a deflection pulley;

FIG. 2 shows a top view of a region of the link conveyor which is shown in a partially sectional view;

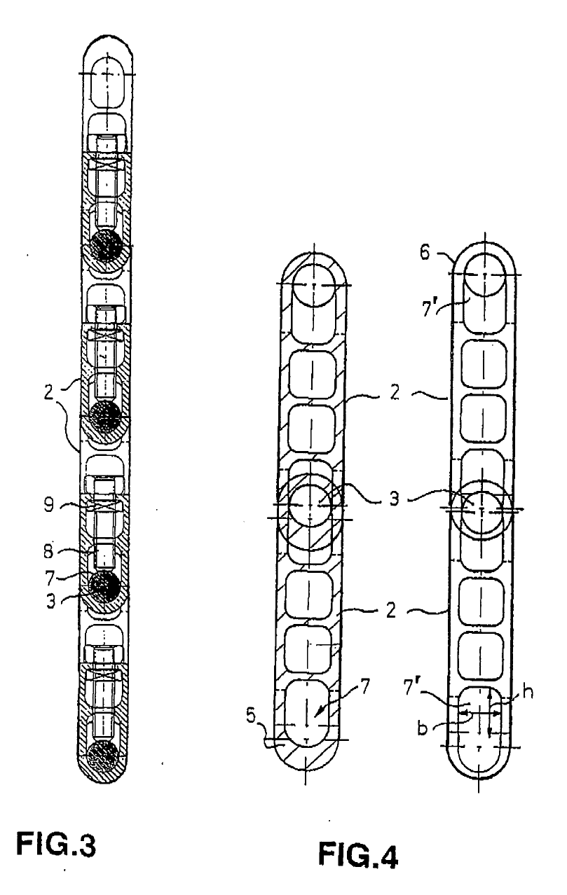

FIG. 3 shows a sectional side view according to arrow A in FIG. 2 with a representation of the possibility for fixation;

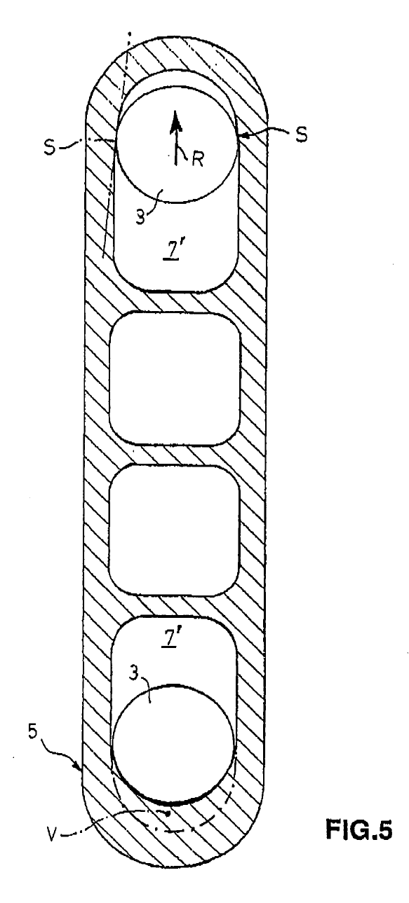

FIG. 4 shows an enlarged representation of two link strips, once in the new state (left) and once on reaching the wearing limit (right), and

FIG. 5 shows a further enlarged representation of a link strip with clamping of a round rod during the stretching process.

FIG. 1 shows a link strip 1 which consists of a plurality of link strips 2. When used in a round-bale press according to the aforementioned state of the art, approximately 200 link strips 2 are provided for example for forming the link conveyor 1, so that in the case of an individual width of approx. 60 mm a total length of the link conveyor 1 of approximately 12 meters is obtained. The link strip 1 revolves in this case about several drive and deflection pulleys 4. Only one is shown here. Said deflection pulley 4 is provided with a polygonal profile which is adjusted to the strip width (of approximately 60 mm in this case), so that even in the tensioned or stretched state a secure drive is still ensured even when the serviceable life has been reached.

The wear of the link conveyor 1 is obtained especially by the wear in the region of the round rods 3 which form the link points for the link strips 2. Since the link conveyor is subjected to very rough conditions especially when garbage is compacted and especially the link points come into direct contact with dust and dirt, the configuration of these link points at the round rods 3 is essential. As a result, each end 5 of each link strip 2 which is the leading one in the running direction of the conveyor (see arrow in FIGS. 1 and 2) is provided with a thicker wall thickness In order to thus define a kind of “wearing zone” (also see region V In FIG. 5). The trailing end 6 of each link strip 2 (see also FIGS. 4 and 5) is extruded with a wall thickness which remains the same relative to the former thickness. It could also be provided with a thicker wall thickness for example.

FIG. 2 shows a top view of a link conveyor 1 which shows the respective meandering configuration of the link strips 2, as also the round rods 3 inserted therein. The figure also shows the increased wall thickness for the leading end 5, especially relative to the remaining wall thicknesses of the multi-chamber extruded profiles. It also shows the configuration of the link point as an oblong hole profile 7 into which a round rod 3 is inserted. It Is fixed by a screw 8 each which is aligned In the running direction of the conveyor.

FIG. 3 shows an enlarged illustration of said fixing possibility in a side view. The said screws 8 are fixed by means of locknuts 9 in or on an adjacent chamber of the link profile 2, thus enabling a secure fixing of the round rods 3 in the oblong hole profile 7, especially when the round rods 3 are flattened off at their ends at the points of attack of the screws 8. The relevant aspect is the configuration of the oblong hole profile 7 with a semi-circular region and an adjacent rectangular hole region 7′.

According to the enlarged representation in FIG. 4 (and also FIG. 5), said rectangular hole region 7′ has a width b which is slightly larger than the diameter of the round rod 3. This leads to an especially simple insertion of the round rods 3 during the assembly or exchange of the link conveyor 1. Moreover, the insertion of the round rods 3 is achieved by a predetermined height h of the rectangular hole region 7′ which is slightly larger than the diameter of the round rod 3.

As is shown in FIG. 4 (left half) on an enlarged scale, the respective leading end 5 of the link strips 2 comprises a zone which is enlarged relative to the remainder of the wall thickness, thus leading to a defined wearing zone. The right region of FIG. 4 shows the state of the link strips 2 on reaching the wearing limit, as can also be seen from the stretched length and the narrowed wearing zone. The service life is substantially increased relative to the aforementioned state of the art, because as opposed to the bores proposed there it is possible to provide the round rods 3 with a thicker configuration, thus reducing the surface pressing in the link points at similar dimensions otherwise.

FIG. 5 below shows the wearing zone marked with reference numeral V and in broken lines. The upper region of FIG. 5 shows an enlarged illustration of the transition of the oblong hole profile 7 (or more precisely its rectangular hole region 7′) to the semi-circular area on which the round rod 3 rests. The transition is provided with conically or acutely tapering inclines S. The inclines S are inclined by a few degrees of angle (approximately 8°) relative to the middle axis, as can be seen from the double dot-dash “tangent”. As an alternative to fastening with screws according to FIG. 3, this also leads to a fixing of the round rod 3 because the same is pulled during the tensioning and stretching movement (according to arrow R) into the thus formed eye of the oblong hole profile 7 and is clamped axially and rotationally by the widening of the eye region. Notice must be taken that this clamping can be detached very easily by a slight blow of the hammer on the round rod 3 in the opposite direction, which is of relevant importance for the disassembly of strongly soiled or even corroded link conveyors.

Although the proposed link conveyor is especially suitable for round bale presses of the kind mentioned above, it can also be used for armored sliding doors, conveyor belts, chain belts in piste caterpillars and the like. Depending on the respective application, driver webs or other profilings can be provided on the flat sides.

1. A link conveyor comprising a plurality of aluminum link strips which comprise multi-chamber extruded profiles which are mutually interconnected at their ends in an articulated manner by means of round rods, characterized in that the round rods are inserted into oblong hole profiles.

2. A link conveyor as claimed in claim 1, characterized in that the oblong hole profiles comprise one each of a semi-circular region and an adjacent rectangular hole region whose width is slightly larger than the diameter of the round rods.

3. A link conveyor as claimed in claim 2, characterized in that the height of the rectangular hole region is slightly larger than the diameter of the round rods.

4. A link conveyor as claimed in claim 2, characterized in that a transition between rectangular hole region and the semi-circular region, is provided with a continuously mutually approaching arrangement, comprising conical inclines.

5. A link conveyor as claimed claim 1, characterized in that a wall thickness of the semi-circular region of the oblong hole profile is provided with a thicker arrangement than the remainder of the wall thickness of the link strips and is provided as a wearing zone.

6. A link conveyor as claimed in claim 1, characterized in that the round rods are fixed with screws aligned in the running direction of the conveyor or are clamped by means of inclines in the oblong hole profile, which inclines extend inclined by a few degrees of angle.

7. A link conveyor as claimed in claim 6, characterized in that the screws are each fixed by one locknut in a chamber of the link strips.

8. A link conveyor as claimed in claim 1, characterized in that the round rods are made of quenched and subsequently drawn steel.

9. A link conveyor as claimed in claim 1, comprising deflection pulleys for the link conveyor having a polygonal profile.
